(19) United States
(12) Patent Application Publication
(10) Pub. No.: US 2003/0087453 A1
(43) Pub. Date: May 8, 2003

(54) Method and device for producing and screening composite arrangements

(76) Inventors: Gerd Scheying, Stuttgart (DE); Thomas Schulte, Stuttgart (DE); Thomas Brinz, Bissingen Unter Der Teck (DE); Valentin Kulikov, Regensburg (DE); Vladimir Mirsky, Sinzing (DE)

Correspondence Address: KENYON & KENYON, ONE BROADWAY, NEW YORK, NY, 10004, US

(21) Appl. No.: 10/143,453

(22) Filed: May 10, 2002

Related U.S. Application Data
(63) Continuation of application No. 09/957,898, filed on Sep. 21, 2001.
Application No. 09/957,898 is a continuation of application No. 09/949,730, filed on Sep. 12, 2001.

(30) Foreign Application Priority Data
Sep. 12, 2000 (DE) 100 45 307.4
Jul. 2, 2001 (DE) 101 31 581.3

(51) Int. Cl. G01N 27/12

(52) U.S. Cl. 436/151; 422/88; 422/98

(57) ABSTRACT

A method and a device are described for producing and/or screening composite arrangements, especially of layer [laminated; coated] composite arrangements, with respect to one desired property, a plurality of composite arrangements (16a, 16b, . . . , 26a, 26b, . . . ) being produced in continuous form, in that on a substrate (10, 20) at at least two defined points (11a, and 11b, . . . , 21a, 21b, . . . ) at least one educt is applied in each case for at least two different materials and the latter are synchronously subjected to the same reaction conditions for the formation of the materials. In this context, one material along with one point (11a, the 11b, . . . , 21a, 21b, . . . ) of the substrate constitutes one composite arrangement (16a, 16b, . . . , 26a, 26b, . . . ). A change in one property of each composite arrangement (16a, 16b, . . . 26a, 26b, . . . ) is determined under the influence of an external stimulus, and the composite arrangement (16a, 16b, . . . , 26a, 26b, . . . ) which demonstrates the desired change in the property is selected.

### BACKGROUND INFROMATION

The present invention relates to a method and a device for producing and screening composite arrangements in accordance with the preamble of the independent claims.

Discovering and developing new substances and materials represents a high-priority goal of the material sciences, chemistry and pharmaceutics. However, the search for appropriate composites is very often tied to a great expenditure of time and money. To be able to carry out the search more effectively and economically, a systematic methodology was introduced years ago in pharmaceutics and then in other application areas, the methodology becoming known as “combinational chemistry.” In this context, a plurality of potentially interesting composites were produced and analyzed in parallel. The advantage of this method is seen in the possibility of automatization, permitting a large throughput rate in the shortest time.

An encompassing general representation of this modus operandi can be seen, for example, in U.S. Pat. No. 5,985,356, in which it is proposed to apply combinational chemistry, which had been used mainly in pharmaceutics, to the application areas of chemistry and material sciences.

One basic disadvantage of the known method is that only the properties of the substances generated on a substrate can be investigated, it not having been possible to investigate composite systems made up of an intimate bonding of at least two different components.

The objective of the present invention is to make available a device and a method which permit the production and screening of composite arrangements effectively and economically.

### ADVANTAGES OF THE INVENTION

The method and the device according to the present invention have the advantage that a plurality of composite arrangements can be rationally produced and screened in continuous form. Above all, this results from the use of one substrate as the common component of all composite arrangements, onto which educts of different materials are deposited at defined points and are reacted synchronously under comparable reaction conditions. The screening of the composite arrangements is accomplished with respect to one selected characteristic, whose change is monitored in response to the influence of an external stimulus.

The method according to the present invention is especially well-suited for developing new materials for sensors, emphasis being placed here on the application in gas sensors. The method according to the invention advantageously makes possible the development both of resistive films for resistive elements as well as of electrode and protective layer materials, for example, for amperometric and potentiometric sensors.

The composite arrangements can advantageously be exposed to the greatest variety of gases, and the potential created on the composite arrangements in the process, a pump current flowing in the composite arrangements, or the resistance of a resistive film provided in the composite arrangement is measured. Additionally, a possibility for heating the substrate and a means for the supply of a reference medium are provided.

An electrical contacting of the composite arrangements makes possible a controlled addressing of individual composite arrangements. This can take place, for example, by using a reversible contact of the contacting surfaces of the individual composite arrangements.

### DRAWING

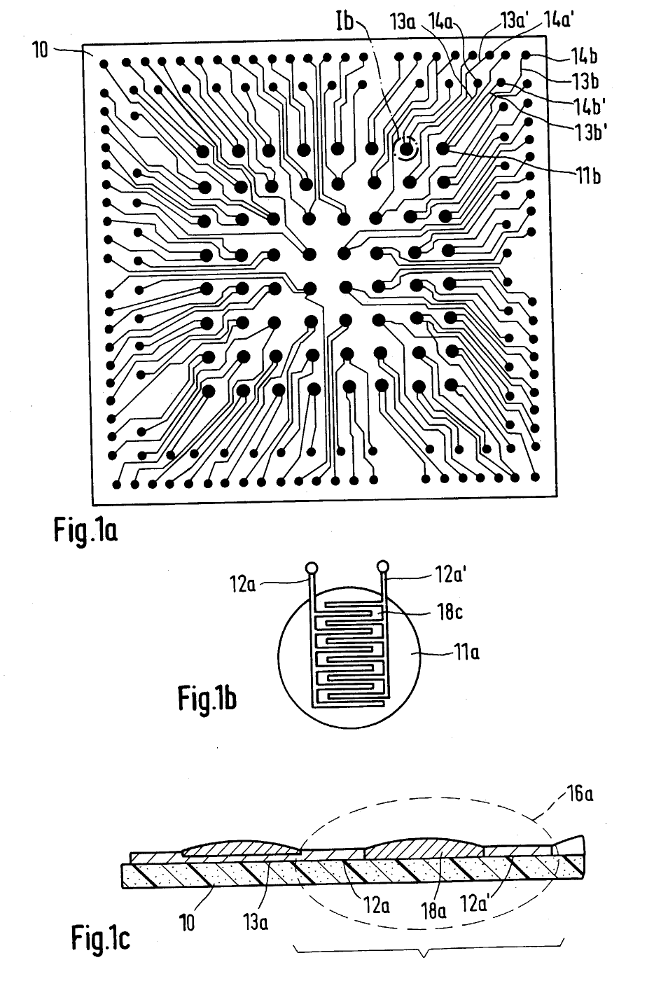

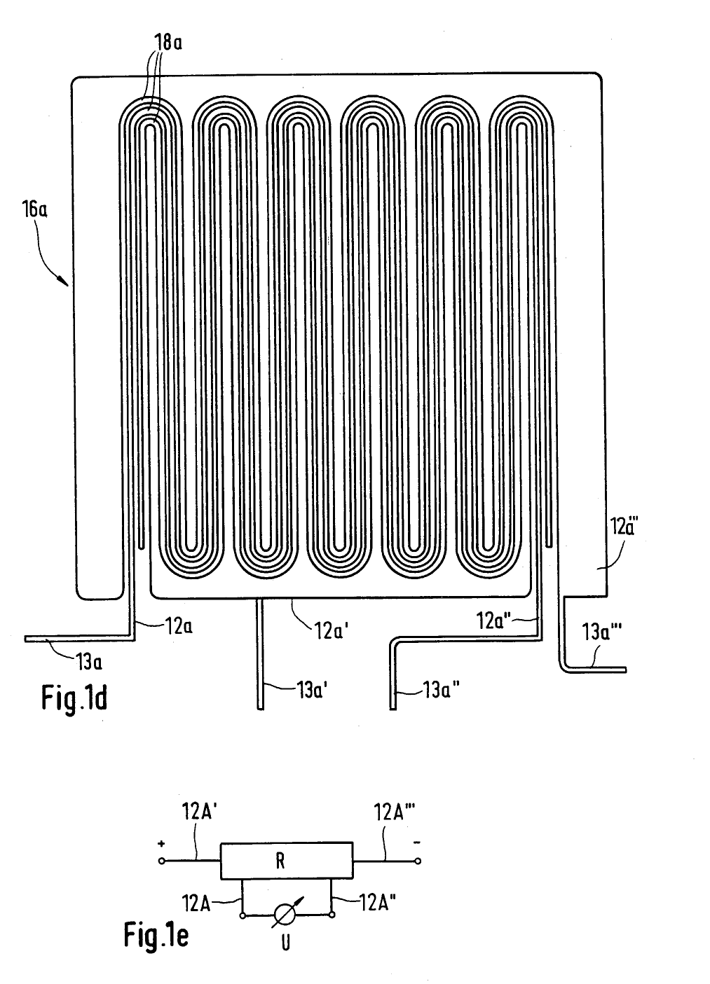

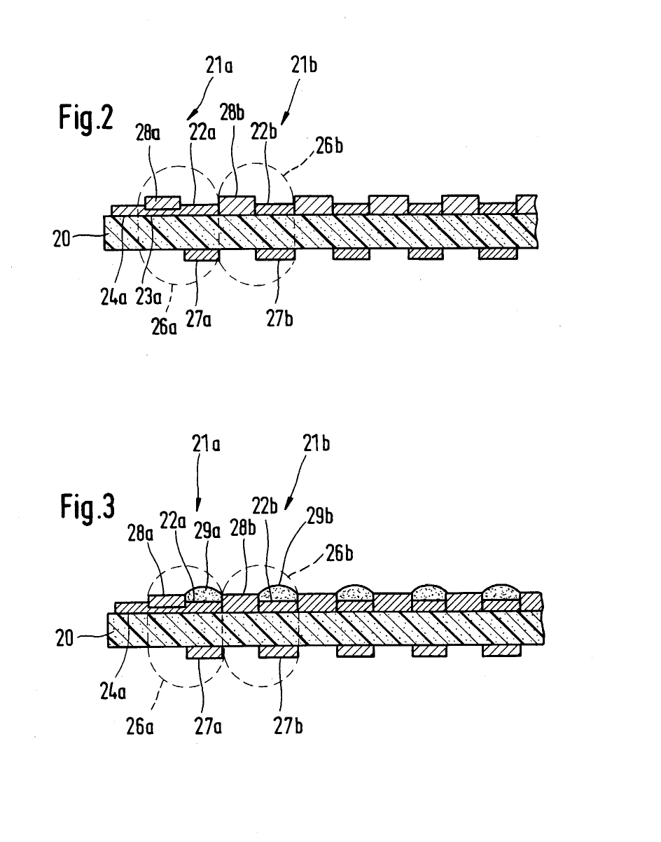

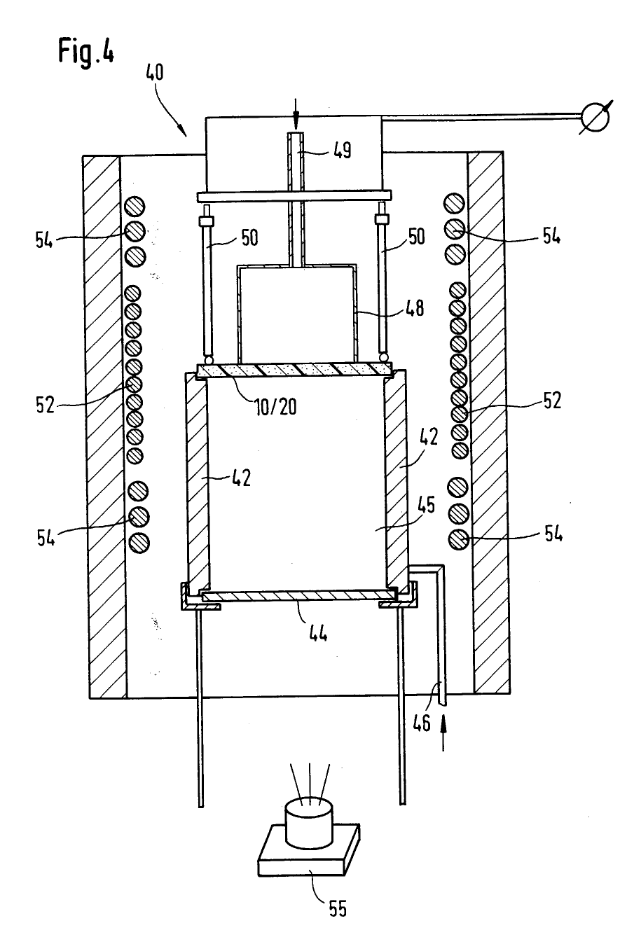

Two exemplary embodiments of the present invention are depicted in the drawing and are discussed in greater detail in the description below. FIG. 1a schematically depicts a top view of a substrate having composite arrangements according to a first exemplary embodiment, FIG. 1b depicts an enlarged view of a segment of FIG. 1a, FIG. 1c depicts a cross-section of the substrate depicted in FIG. 1a, FIG. 1d depicts a variant of the segment enlargement shown in FIG. 1b, FIG. 1e depicts an equivalent [circuit] diagram for the variant shown in FIG. 1d, FIGS. 2 and 3 depict cross-sections of substrates according to a further exemplary embodiment, and FIG. 4 shows a device for carrying out the method according to the present invention.

### EXEMPLARY EMBODIMENTS

The idea underlying the present invention is to extend the methodology of a parallel synthesis and screening of different potentially interesting substances to research areas in which it is not the investigation of the properties of individual materials separately that constitutes the goal, but rather only investigations of arrangements which are composed of two or more components that lead to meaningful results. This is the case, inter alia, in the area of sensor systems. For example, it is possible to investigate a metallic composite with respect to its conductivity using the heretofore known methods. But whether this composite is suited as a measuring electrode of a sensor can only be adequately tested if the metallic composite is manufactured and investigated, for example, in a composite along with a solid electrolyte, a counter-electrode, and, if appropriate, an electrode protective layer.

Generally, for this purpose, at least one educt for producing at least two materials is applied to a substrate at at least two points, whose precise position on the substrate is known. The dosing and deposition can take place using the customary methods, for example, using a dispenser. The substrate provided with educts is exposed to reaction conditions that bring about not only the formation of materials from the educts but also at the same time bring about an intimate bonding of the materials to the substrate surface. In this context, a composite arrangement is constituted in each case of one material along with the common substrate, and, if appropriate, along with further components. The composite arrangements thus generated in continuous form are then subjected to a screening for a selected property.

In FIG. 1, for purposes of clarification, a first exemplary embodiment of the device and the method according to the present invention is depicted. The composite arrangements produced in accordance with the first exemplary embodiment are suited, for example, for developing new materials for resistive gas sensors. In this context, a substrate 10 is used, which acts in an electrically insulated manner and which is substantially composed of high-resistance materials such as aluminum oxide or silicon coated with silicon dioxide. On substrate 10, at defined points 11a, 11b, . . . , two electrodes 12a, 12a′, 12b, 12b′, . . . are applied, for example, in the form of interdigital electrodes depicted in the segment enlargement in FIG. 1b. The interdigital electrodes, as is made clear schematically in FIG. 1a, are connected via separate printed circuit traces 13a, 13a′, 13b, 13b′, . . . to contact points 14a, 14a′, 14b, 14b′, . . . at the edge of substrate 10. Contact points 14a, 14a′, 14b, 14b′, . . . can also in principle be arranged on the rear side of substrate 10 and can be contacted via a bore hole.

Finally, printed circuit traces 13a, 13a′, 13b, 13b′, . . . are covered by one or a plurality of different, undepicted inert layers. Deposited in the areas between electrodes 12a, 12a′, 12b, 12b′, . . . are additional resistive films 18a, 18b, . . . , which can also cover corresponding electrodes 12a, 12a′, 12b, 12b′.

The actual manufacturing process occurs most advantageously by the printing, for example using screen printing techniques, of appropriate pastes containing the necessary materials onto substrate 10 and then by sintering the substrate imprinted by the pastes. In this context, a composite arrangement 16a, 16b, . . . is formed in each case by electrodes 12a, 12a′, 12b, 12b′, . . . , produced at defined points 11a, 11b, . . . , together with substrate 10 and resistive films 18a, 18b, . . .

One variant of the composite arrangements depicted in FIG. 1a and 1b is illustrated in FIG. 1d. In this context, instead of two electrodes 12a, 12a′, four electrodes 12a, 12a′, 12a″, 12a′″ are provided for composite arrangement 16a. In this context, electrodes 12a, 12a″ are preferably configured as meanders running in opposite directions. Between electrodes 12a, 12a″ is located one part of resistive film 18a. Electrodes 12a, 12a″, executed as meanders, are surrounded on one side by third electrode 12a′, and on the other side by fourth electrode 12a′″, further parts of resistive film 18a being located between electrodes 12a, 12a′ and between electrodes 12a″, 12a′″.

Electrodes 12a′, 12a′″ are acted upon by a current that leads to a voltage drop between electrodes 12a′, 12a′″ and additionally between electrodes 12a, 12a″. Because an additional resistance of an unknown size arises on electrodes 12a′, 12a′″ as a result of the application of the current, the voltage drop at electrodes 12a, 12a′ is used for determining the resistance of resistive film 18a because the disturbing influence of the additional resistance is eliminated at that location.

Electrodes 12a, 12a′, 12a″, 12a′″ are contacted by leads 13a, 13a′, 13a″, 13a′″ having undepicted contact points 14a, 14a′, 14a″, 14a′″, preferably at the edge of the substrate.

In FIG. 1e, for illustrating the mode of functioning of composite arrangement 16a depicted in FIG. 1d, an equivalent-circuit diagram is depicted. In this context, a voltage drop is measured between terminals 12A, 12A″, from which a resistance R2 can be calculated, which represents one part of overall resistance R1, which can be calculated using the voltage drop between terminals 12A′, 12A′″.

Screening the composite arrangements for a desired property takes place under the influence of an external stimulus. In the most general terms, this should be understood as being the direct contact of composite arrangement 16a, 16b, . . . with a medium that interacts physically or chemically with the surface of composite arrangement 16a, 16b, . . . In the present case, it is preferably understood to mean the influence of gases, especially those which are to be detected by the sensor under development.

Screening composite arrangement 16a, 16b, . . . with respect to a desired property can occur, for one thing, with respect to an optimization of resistive films 18a, 18b, . . . with reference to their ohmic resistance, impedance, or capacitance, as a function of the concentration of the gas component to be determined. For this purpose, the composition and the stoichiometry of inert layers 18a, 18b, . . . , applied at individual points 11a, 11b, . . . , are varied. In addition, there is also the possibility of developing a composite arrangement that is sensitive to the gas or fluid components that are to be detected by varying the composition and the stoichiometry of electrodes 12a, 12a′, 12a″, 12a′″, 12b, 12b′, . . . and of printed circuit traces 13a, 13a′, 13a″, 13a′″, 13b, 13b′, . . .

The number of points 11a, 11b, . . . to be provided on substrate 10 can be varied. It depends on practical considerations. Thus, in the case of a number of points smaller than 16, the advantages of a parallel synthesis and screening of composite arrangement 16a, 16b, . . . are scarcely noticeable, whereas an upper limit is only given regarding a sufficiently effective management of the quantity of data obtained and regarding a sufficiently precise covering of the substrate surface using the circuit traces 13a, 13a′, 13a″, 13a′″, 13b, 13b′, . . . and inert layers 18a, 18b, . . . A number of points 11a, 11a′, . . . that according to experience is easy to manipulate is around 256.

Composite arrangements 16a, 16b, . . . , described in the context of the first exemplary embodiment, can also be used in a modified form for the development of new kinds of potentiometric and amperometric sensors. A cross-section of a substrate 20 having composite arrangements 26a, 26b, . . . , that can be used for this purpose, is depicted in FIG. 2. Substrate 20, upon which this second exemplary embodiment is based, includes an ion-conductive solid electrolyte, such as zirconium dioxide that is partially or totally stabilized using yttrium oxide. If the sensors to be developed are not to be based on an oxygen-ion conductivity of the solid electrolyte but rather on an ionic conductivity based on protons or alkali ions, then it is also conceivable to use solid electrolyte materials such as Nasicon or polyelectrolyte membranes from fuel cell technology.

On substrate 20, at defined points 21a, 21b, . . . , electrodes are applied in the form of measuring electrodes 22a, 22b, . . . The latter are connected via a separate printed circuit trace 23a, 23b, . . . to contact points 24a, 24b, . . . at the edge of substrate 20. Contact points 24a, 24b, . . . can be applied to the same surface of substrate 20 on which measuring electrodes 22a, 22b are disposed, but they can also be configured on the surface of substrate 20 facing away from measuring electrodes 22a, 22b. Printed circuit traces 23a, 23b, . . . and the interstitial spaces between electrodes 22a, 22b, . . . are covered by inert layers 28a, 28b, . . . , the surfaces of measuring electrodes 22a, 22b, . . . and contact surfaces 24a, 24b, . . . nevertheless remaining uncovered. On the surface of substrate 20 facing away from measuring electrodes 22a, 22b, . . . , reference electrodes 27a, 27b, . . . are applied, either, in accordance with the application case, each measuring electrode 22a, 22b, . . . having assigned to it a reference electrode 27a, 27b, . . . , or a plurality or all reference electrodes 27a, 27b, . . . being combined in one common reference electrode.

The surfaces of some or all measuring electrodes 22a, 22b, . . . , as depicted in FIG. 3, can additionally be at least partially covered by a porous protective layer 29a, 29b, . . . This is significant above all for the development of amperometric sensors. The production of composite arrangements 26a, 26b, . . . occurs through employing appropriate printing processes on substrate 20 and through a subsequent sintering of the printed substrate in the manner already described.

To screen composite arrangements 26a, 26b, . . . , produced in continuous form, with respect to their sensitivity regarding the composites to be detected, for a potentiometric mode of measuring, measuring electrodes 22a, 22b, . . . are connected to reference electrode(s) 27a, 27b, . . . to form so-called Nernst or concentration cells. During the measuring, one or a plurality of measuring electrodes 22a, 22b, . . . are exposed to a measuring gas atmosphere, which contains the components to be detected, whereas reference electrodes 27a, 27b, . . . are exposed to a reference atmosphere. For each composite arrangement 26a, 26b, . . . , the potential difference occurring between the measuring and reference electrodes is determined as a function of the concentration of the gas components to be detected in the measuring gas atmosphere.

In this context, depending on the design of the manufacturing process, it is possible to vary the materials of measuring electrodes 22a, 22b, . . . , of solid electrolyte 10, 20, or of protective layers 29a, 29b,... that are arranged on measuring electrodes 22a, 22b, . . . Both the stoichiometry of the materials as well as the type and number of educts producing the materials can be varied.

The mode of operation of composite arrangements 26a, 26b, . . . , used as amperometric sensors, usually presupposes the existence of porous protective layers 29a, 29b, . . . on measuring electrodes 22a, 22b, . . . as a diffusion resistance. In this context, porous protective layers 29a, 29b, . . . , as is depicted in FIG. 3, at least partially cover the surfaces of measuring electrodes 22a, 22b, . . . ; however, protective layers 29a, 29b, . . . can also be executed in the form of a continuous layer covering the entire substrate. In an amperometric mode of operation, measuring electrodes 22a, 22b, . . . of the composite arrangements are connected to reference electrode(s) 27a, 27b, . . . to form electrochemical pump cells, a pump voltage being applied between the measuring and reference electrodes, and the pump current flowing between the measuring and reference electrodes being determined.

As gas components, which can be determined using a composite arrangement 16a, 16b, . . . 26a, 26b, . . . in accordance with the first or second exemplary embodiment, oxygen, nitrous oxide, sulfur oxide, carbon monoxide, hydrocarbons, ozone, ammonia, hydrogen, and hydrogen sulfide can be mentioned, among others.

In FIG. 4, a device 40 is schematically represented which is for screening composite arrangements 16a, 16b, . . . , 26a, 26b, . . . that are generated in continuous form for one desired property. Substrate 10, 20, in this context, is placed on an object carrier 42, which at the same time can be executed so that, as is depicted in FIG. 4, it forms, together with a further limiting plate 44, a reference space 45 for the supply of a reference medium. The reference medium can be supplied via a supply line 46 to reference space 45. On the surface of substrate 10, 20 facing away from reference space 45, a rectangular measuring bell 48 is provided for supplying a liquid or gaseous measuring medium, the bell having a supply line 49 for the measuring medium and being able to be lowered onto the substrate surface. Using measuring bell 48, a measuring medium is applied to the sensitive areas of composite arrangement 16a, 16b, . . . , 26a, 26b, . . . , disposed on the substrate surface.

Furthermore, the device has a means 50 for the preferably reversible and addressable contacting of contact points 14a, 14b, . . . 24a, 24b, . . . that are applied to substrate 10, 20. This means 50 makes possible the targeted contacting of different composite arrangements 16a, 16b, . . . 26a, 26b, . . . , and the picking off of the measuring values resulting from the influence of the measuring medium.

Because solid electrolytes only possess a noticeable ionic conductivity at high temperatures of greater than 400° C., ionic conductivity being a basic prerequisite for the functional viability of composite arrangements 16a, 16b, . . . , 26a, 26b, . . . as potential sensors, a heater 52 is provided in device 40 preferably perpendicular to the plane of substrate 10, 20, the heater heating composite arrangements 16a, 16b, . . . , 26a, 26b, . . . to the required temperature. Additionally, it is possible to screen the sensitive properties of composite arrangement 16a, 16b, . . . , 26a, 26b, . . . with respect to a variation of the measuring temperature. A cooling system 54 can also optionally be provided for the area of reference space 45 and/or of measuring bell 48.

In addition, as an alternative to detection by picking off electrical measuring quantities, a photographic imaging device 55 for infrared radiation can advantageously be provided, the device being able, using photographic means, to localize especially active centers on the substrate surface due to their more pronounced heating.

The present invention is not limited to the exemplary embodiments described, but, depending on the application purpose, other embodiments of the present invention are conceivable in addition to those described. Thus, for example, in selecting the corresponding substrates and the sensitive materials, the manufacture and screening of liquid sensors with respect to one selected property can be carried out using the method and the device underlying the present invention.

What is claimed is:

1. A method for producing and/or screening composite arrangements, especially of layer [laminated, coated] composite arrangements, with respect to one desired property, a plurality of composite arrangements (16a, 16b, . . . , 26a, 26b, . . . ) being produced in continuous form, in that on a substrate (10, 20) at at least two defined points (11a, 11b, . . . , 21a, 21b, . . . ) at least one educt is applied in each case for at least two different materials and the latter are synchronously subjected to the same reaction conditions for the formation of the materials, in each case one material along with one point (11a, 11b, . . . , 21a, 21b, . . . ) of the substrate constituting one composite arrangement (16a, 16b, . . . , 26a, 26b, . . . ), a change in one property of each composite arrangement (16a, 16b, . . . 26a, 26b, . . . ) being determined under the influence [action] of an external stimulus, and the composite arrangement (16a, 16b, . . . , 26a, 26b, . . . ) which demonstrates the desired change in the property being selected.

2. The method as recited in claim 1,
wherein the external stimulus is the influence of a gaseous or liquid substance, which is specifically to be detected.

3. The method as recited in claim 1,
wherein each composite arrangement (26a, 26b, . . . ) is electrically contacted, and the level of an electrical potential forming on the surface of the material is selected as the property which changes under the influence of an external stimulus.

4. The method as recited in claim 1,
wherein each composite arrangement (26a, 26b, . . . ) is electrically contacted, a voltage is applied to the composite arrangement (26a, 26b, . . . ), and the level of the pump current flowing within the composite arrangement (26a, 26b, . . . ) is selected as the property that changes under the influence of an external stimulus.

5. The method as recited in claim 1,
wherein each composite arrangement (16a, 16b, . . . ) is electrically contacted, a voltage is applied to the composite arrangement (16a, 16b, . . . ), and the ohmic resistance, the capacitance, and/or the impedance of the material belonging to the composite arrangement (16a, 16b, . . . ) is selected as the property that changes under the influence of an external stimulus.

6. The method as recited in claim 1,
wherein the speed of a change [rate of change] of a property of each composite arrangement (16a, 16b, . . . , 26a, 26b, . . . ) is determined under the influence of an external stimulus that changes over time, and the composite arrangement (16a, 16b, . . . , 26a, 26b, . . . ) that demonstrates the desired speed in the change of the property is selected.

7. The method as recited in claim 1,
wherein the substrate (10, 20) is heated, while a change in one property of each composite arrangement (16a, 16b, . . . , 26a, 26b, . . . ) is determined under the influence of an external stimulus.

8. A device for producing and/or screening composite arrangements, especially of layer [laminated; coated] composite arrangements, with respect to one desired property, having a substrate (10, 20), on which at least two defined points (11a, 11b, . . . , 21a, 21b, . . . ) are located, onto each of which at least one educt of at least two different materials can be applied, the educts being convertible to the materials by synchronously reacting the educts under identical reaction conditions, and in each case one material along with one point (11a, 11b,. . . , 21a, 21b, . . . ) of the substrate (10, 20) forming one composite arrangement (16a, 16b, . . . , 26a, 26b), wherein a means (50) is provided on the substrate (10, 20) for the preferably reversible electrical contacting of contact points (14a, 14b, . . . , 24a, 24b, . . . ), so that a plurality of composite arrangements (16a, 16b, . . . , 26a, 26b, . . . ) are electrically addressable.

9. The device as recited in claim 8,
wherein the number of points (11a, 11b, . . . 21a, 21b, . . . ) on the substrate (10, 20) for the application of educts is equal to the number of possible combinations of elements x to the power of y, x corresponding to the number of the different selected educts and y corresponding to the number of educts necessary for one material.

10. The device as recited in claim 8,
wherein the number of points (11a, 11b, . . . 21a, 21b, . . . ) on the substrate (10, 20) for the application of educts is equal to a series of different stoichiometric composites of one material made of at least two educts.

11. The device as recited in claim 8,
wherein the number of points (11a, 11b, . . . , 21a, 21b, . . . ) is at least 16 and is preferably around 256.

12. The device as recited in claim 8,
wherein the substrate (10, 20) includes aluminum oxide, silicon provided with silicon dioxide, and/or a solid electrolyte.

13. The device as recited in claim 8,
wherein the material is contacted by two or four printed circuit traces (13a, 13b, . . . ).

14. The device as recited in claim 13,
wherein the material includes one oxide.

15. The device as recited in claim 8,
wherein on the side of the substrate (20) opposite from the material at least one reference electrode (27a, 27b, . . . ) is configured.

16. The device as recited in claim 8,
wherein the material is contacted as a measuring electrode (22a, 22b, . . . ).

17. The device as recited in claim 16,
wherein the material is a cermet.

18. The device as recited in claim 8,
wherein the material is applied as a layer [coating] (29a, 29b, . . . ) over a measuring electrode (22a, 22b, . . . ) that is additionally arranged on the substrate (20).

19. The device as recited in claim 18,
wherein the material is porous and preferably contains a catalytically active metal in finely divided form.

20. The device as recited in claim 8,
wherein a feed [inlet] (49) is provided for a measuring gas.

21. The device as recited in claim 8,
wherein a reference gas can be supplied on the side of the substrate (10, 20) facing away from the materials.

22. The device as recited in claim 8,
wherein a photographic imaging device (55) is provided for UV, IR, and/or visible light.

23. A device for producing and/or screening composite arrangements, especially of layer [laminated; coated] composite arrangements, with respect to one desired property, having a substrate (10, 20), on which at least two defined points (11a, 11b, . . . , 21a, 21b, . . . ) are located, onto each of which at least one educt of at least two different materials can be applied, the educts being convertible to the materials by synchronously reacting the educts under identical reaction conditions, and in each case one material along with one point (11a, 11b, . . . , 21a, 21b, . . . ) of the substrate (10, 20) forming one composite arrangement (16a, 16b, . . . , 26a, 26b), wherein a means (50) is provided on the substrate (10, 20) for the preferably reversible electrical contacting of contact points (14a, 14b, . . . , 24a, 24b, . . . ), so that a plurality of composite arrangements (16a, 16b, . . . , 26a, 26b, . . . ) are electrically addressable, characterized as a means for carrying out a method in accordance with claim 1.

24. The use of a method as recited in claim 1 for developing measuring electrodes for gas sensors.

25. The use of a method as recited in claim 1 for developing protective layers for measuring electrodes of gas sensors.

26. The use of a method as recited in claim 1 for developing gas sensors for determining NOₓ, hydrocarbons, NH₃, CO, H₂, SOₓ, H₂S, and/or O₃.

27. The use of a device as recited in claim 8 for developing measuring electrodes for gas sensors.

28. The use of a device as recited in claim 8 for developing protective layers for measuring electrodes of gas sensors.

29. The use of a device as recited in claim 8 for developing gas sensors for determining NOₓ, hydrocarbons, NH₃, CO, H₂, SOₓ, H₂S, and/or O₃.
